(19) United States
(12) Patent Application Publication
(10) Pub. No.: US 2025/0328865 A1
(43) Pub. Date: Oct. 23, 2025

(54) Systems, Methods and Apparatus to Integrate Distributed, Multitenant-Capable Full-Text Search Engine and Multiple Data Set Databases with Generative Machine Learning

(71) Applicant: Biointelli Corporation, Cambridge, MA (US)

(72) Inventor: David Hines, Cambridge, MA (US)

(73) Assignee: Biointelli Corporation, Cambridge, MA (US)

(21) Appl. No.: 18/674,913

(22) Filed: May 26, 2024

Related U.S. Application Data
(60) Provisional application No. 63/637,871, filed on Apr. 23, 2024.

(51) Int. Cl. G06Q 10/10

(52) U.S. Cl. CPC G06Q 10/103

(57) ABSTRACT

An identity and access management component is coupled to a distributed multitenant-capable full-text search engine is coupled to a source-available data visualization dashboard that is coupled to a cloud storage component that is coupled to an import worker that is coupled to a life science journal database, the distributed multitenant-capable full-text search engine is coupled to a sync-worker; the identity and access management component is coupled to a database manager and database is coupled to the import worker and the sync-worker and an import worker is coupled to a business information database; the database manager is coupled to a sales-enablement tool; the database manager is coupled to a queue worker which is coupled to a clinical trial database; the identity and access management component and the queue worker are coupled to a storage system; the identity and access management component is coupled to an object storage and email server.

### RELATED APPLICATIONS

This application claims the benefit under 35 U.S.C. 119(e) of U.S. Provisional Application Ser. No. 63/637,871 filed 23 Apr. 2024.

### FIELD

This disclosure relates generally to scientific project communication.

### BACKGROUND OF THE INVENTION

Conventional systems in life science project communications use curated data and enriched data (mainly from public funding databases such as NIH NSF CIHR etc., and foundations, venture capital organizations, scientific conferences, publications etc. However, almost 100% of the public data is missing contact details, such as address, phone, email, etc., which is manually researched and stored in a database.

Conventional systems in life science project communications further enable operators to manually select multiple keywords, scientific phrases, acronyms, scientific modalities in which a country, state(s) and key scientific terms germane to a product portfolio are entered and saved, which requires several hours to manually read through the award, scientific abstract, and then manually write, a highly technical, highly personalized email to book a meeting with the scientist of lab staff to discuss technical aspects of the research.

### SUMMARY OF THE INVENTION

The above-mentioned shortcomings, disadvantages and problems are addressed herein, which will be understood by reading and studying the following specification.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes an apparatus operable to manage a life science project communication. The apparatus also includes a microprocessor, a first receiver being operably coupled to the microprocessor and having computer instructions that when executed receive a curated data and an enriched data, a second receiver being operably coupled to the microprocessor and having computer instructions that when executed receive multiple keywords, scientific phrases, acronyms, scientific modalities in which a country, state(s) and key scientific terms that are germane to a product portfolio are entered and saved, a generator of the life science project communication operably coupled to the microprocessor and having computer instructions that when executed generate the life science project communication from the curated data and the enriched data and from the multiple keywords, the scientific phrases, the acronyms, the scientific modalities in which the country, the state(s) and the key scientific terms that are germane to the product portfolio, and a transmitter being operably coupled to the microprocessor and having computer instructions that when executed transmit the life science project communication. Other embodiments of this aspect include corresponding computer systems, apparatus, and computer programs recorded on one or more computer storage devices, each configured to perform the actions of the methods.

Implementations may include one or more of the following features. An apparatus where the generator of the life science project communication further may include: a second generator being operably coupled to the microprocessor and having computer instructions that when executed generate an A.P.I. request, the A.P.I. request including parameters including a company name, a list of the keywords and abstracts, where the A.P.I. request is a request to a machine learning engine to generate the life science project communication, a second transmitter being operably coupled to the microprocessor and having computer instructions that when executed transmit the A.P.I. request to the machine learning engine, and a third receiver being operably coupled to the microprocessor and having computer instructions that when executed receive the life science project communication from the machine learning engine. Implementations of the described techniques may include hardware, a method or process, or computer software on a computer-accessible medium.

One general aspect includes a life science project communications method that includes receiving curated data and enriched data, receiving multiple keywords, scientific phrases, acronyms, scientific modalities in which a country, state(s) and key scientific terms germane to a product portfolio are entered and saved, generating a life science project communication, and transmitting the life science project communication. Other embodiments of this aspect include corresponding computer systems, apparatus, and computer programs recorded on one or more computer storage devices, each configured to perform the actions of the methods.

Implementations may include one or more of the following features. A method where generating the life science project communication further may include: generating an A.P.I. request, the A.P.I. request including parameters including company name, a list of keywords and abstracts, where the A.P.I. request is a request to a machine learning engine to generate the life science project communication, transmitting the A.P.I. request to the machine learning engine, and receiving the life science project communication from the machine learning engine. Implementations of the described techniques may include hardware, a method or process, or computer software on a computer-accessible medium.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF DRAWINGS

FIG. 1 is a block diagram of an overview of a life science project communications system to manage a life science project communication, according to an implementation.

FIG. 2 is a block diagram of an apparatus of a life science project communications apparatus to manage a life science project communication, according to an implementation.

FIG. 3 is a block diagram of an apparatus of a life science project communications apparatus to manage a life science project communication, according to an implementation.

FIG. 4 is a flowchart of a method to manage a life science project communication, according to an implementation.

FIG. 5 is a flowchart of a method to generating the life science project communication, according to an implementation.

FIG. 6 is a block diagram of a scientific project communication control computer in which different implementations can be practiced.

FIG. 7 is a block diagram of a data acquisition circuit of the scientific project communication control computer, according to an implementation.

FIG. 8 is a block diagram of a hardware and operating environment in which different implementations can be practiced.

FIG. 9 is a block diagram of a scientific project communication control mobile device, according to an implementation.

### DETAILED DESCRIPTION OF THE INVENTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into five sections. In the first section, a system level overview is described. In the second section, apparatus of implementations are described. In the third section, implementations of methods are described. In the fourth section, a hardware and the operating environment in conjunction with which implementations may be practiced are described. Finally, in the fifth section, a conclusion of the detailed description is provided.

### System Level Overview

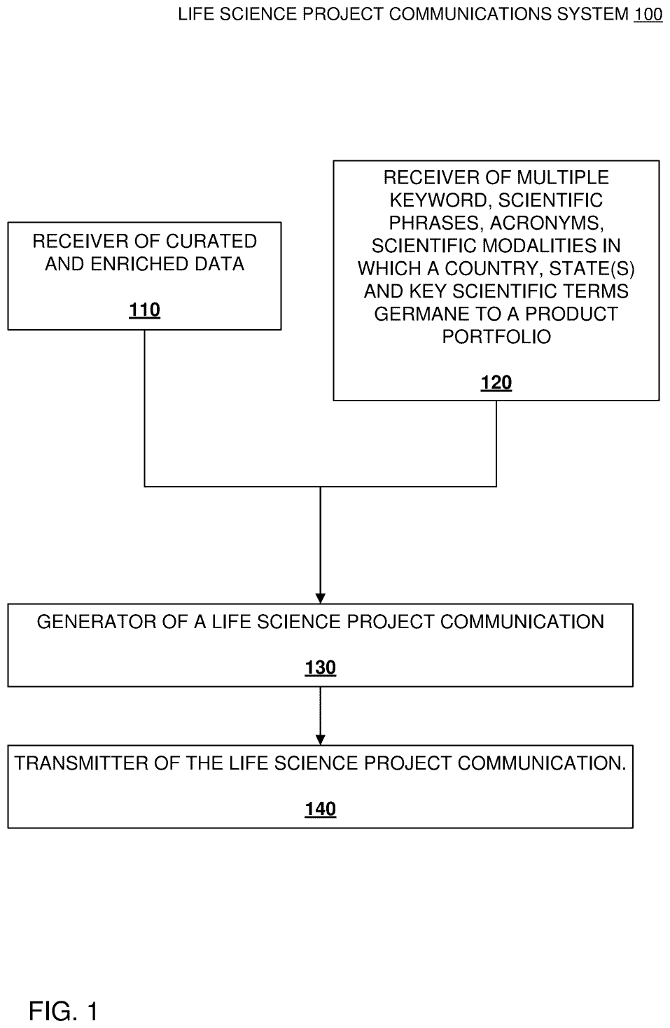

FIG. 1 is a block diagram of an overview of a life science project communications system 100 to manage a life science project communication, according to an implementation. The life science project communications system 100 includes a first receiver 110 that is operable to receive a curated data and an enriched data. The curated data and the enriched data is received from public funding databases, such as a NIH database, a NSF database, a CIHR database, a foundation database, a venture capital organization database, a scientific conference database or a publications database. The public funding databases are missing contact details, such as address, phone, and email address.

The life science project communications system 100 also includes a second receiver 120 that is operably coupled to the first receiver 110 and that is operable to receive multiple keywords, scientific phrases, acronyms, scientific modalities in which a country, state(s) and key scientific terms that are germane to a product portfolio are entered and saved. The life science project communications system 100 also includes a generator 130 of the life science project communication operably coupled to the second receiver 120 and that is operable to generate the life science project communication from the curated data and the enriched data and from the multiple keywords, the scientific phrases, the acronyms, the scientific modalities in which the country, the state(s) and the key scientific terms that are germane to the product portfolio. The life science project communications system 100 also includes a transmitter 140 that is operably coupled to the generator 130 and that is operable to transmit the life science project communication.

While the system 100 is not limited to any particular receiver 110, receiver 120, generator 130 and transmitter 140, for sake of clarity a simplified receiver 110, receiver 120, generator 130 and transmitter 140 are described.

### Apparatus Implementations

In the previous section, a system level overview of the operation of an implementation was described. In this section, the particular apparatus of such an implementation are described by reference to a series of diagrams.

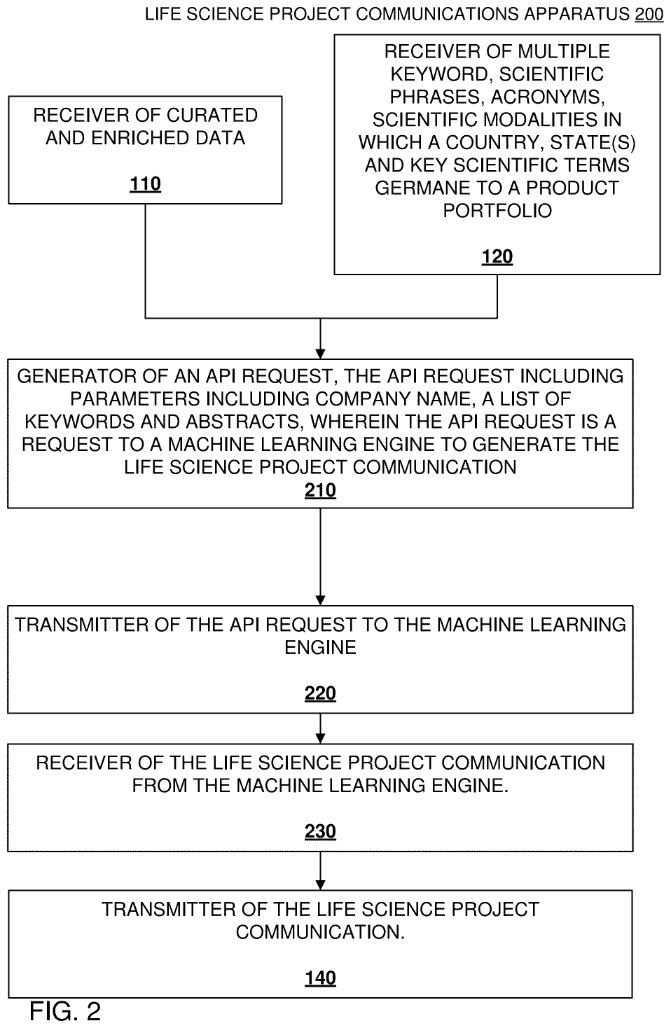

FIG. 2 is a block diagram of an apparatus of a life science project communications apparatus 200 to manage a life science project communication, according to an implementation. The life science project communications apparatus 200 includes a first receiver 110 that is operable to receive a curated data and an enriched data. The life science project communications apparatus 200 also includes a second receiver 120 that is operably coupled to the first receiver 110 and that is operable to receive multiple keywords, scientific phrases, acronyms, scientific modalities in which a country, state(s) and key scientific terms that are germane to a product portfolio are entered and saved. The life science project communications apparatus 200 also includes a second generator 210 being operably coupled to the second receiver 120 that is operable to generate an API request, the API request including parameters including a company name, a list of the keywords and abstracts, wherein the API request is a request to a machine learning engine to generate the life science project communication, the life science project communications apparatus 200 also includes a second transmitter 220 being operably coupled to the second generator 210 that is operable to transmit the API request to the machine learning engine. the life science project communications apparatus 200 also includes a third receiver 230 being operably coupled to the second transmitter 220 that is operable to receive the life science project communication from the machine learning engine. The life science project communications apparatus 200 also includes a transmitter 140 that is operably coupled to the third receiver 230 and that is operable to transmit the life science project communication.

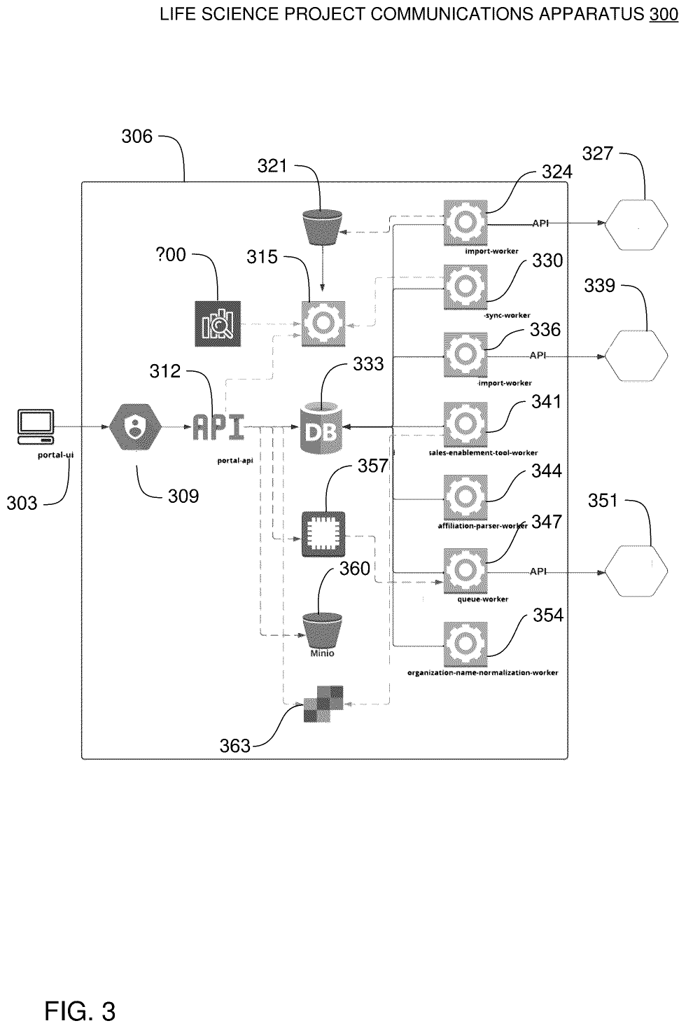

FIG. 3 is a block diagram of an apparatus of a life science project communications apparatus 300 to manage a life science project communication, according to an implementation.

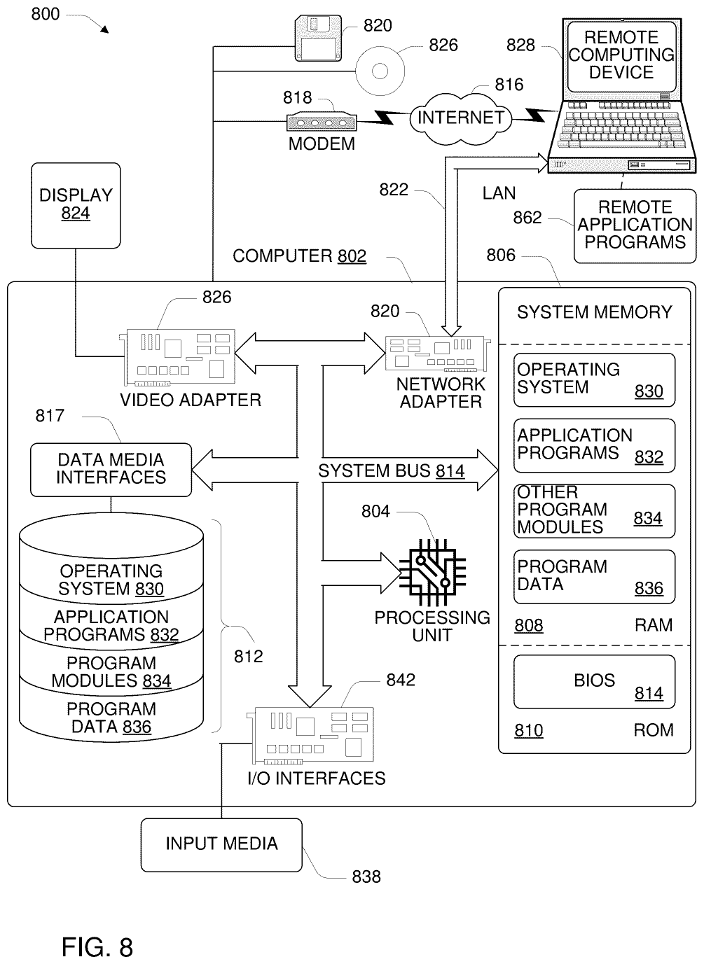

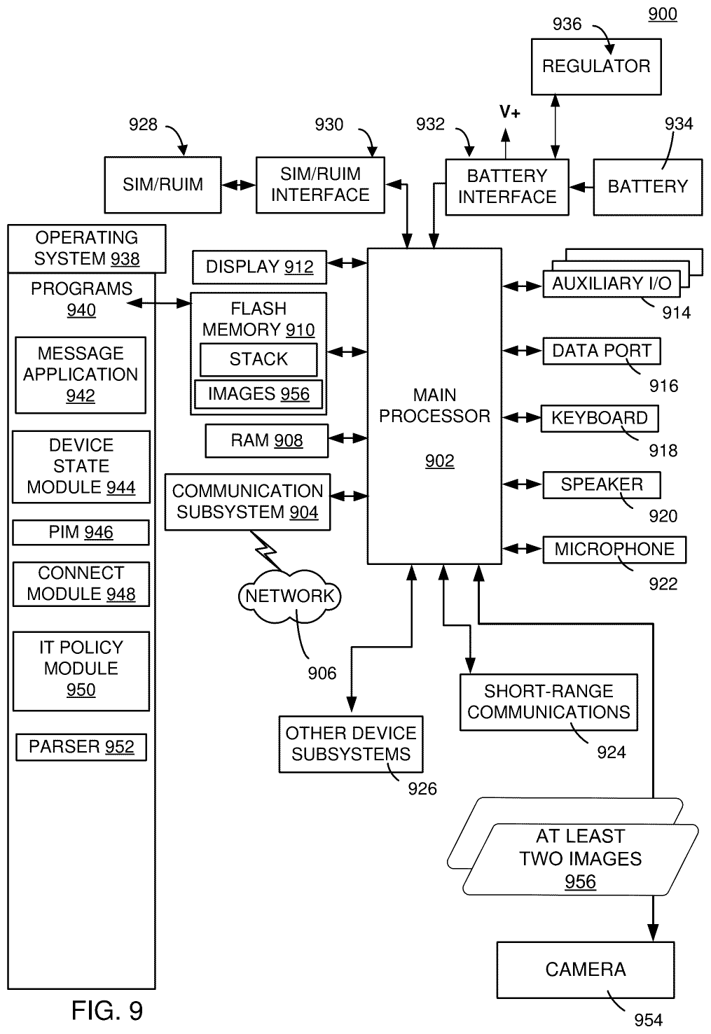

Apparatus 300 includes a computer 303, such as computer 800 in FIG. 8 or computer 900 in FIG. 9, that is modified with a proprietary portal user interface to access a proprietary apparatus 306. The proprietary apparatus 306 includes an identity and access management component 309 that can be operably coupled to the computer 303 and is the only portal to customer computers. One example of the identity and access management component 309 is Keycloak produced by the Cloud Native Computing Foundation. The identity and access management component 309 is operably to a portal application program interface (A.P.I.) 312. The A.P.I. 312 is operably coupled to a distributed, multitenant-capable full-text search engine 315. The distributed, multitenant-capable full-text search engine 315 has an HTTP web interface and schema-free JSON documents. One example of the distributed, multitenant-capable full-text search engine 315 is “Elastic Search” produced by Elasticsearch B.V. The distributed, multitenant-capable full-text search engine 315 is operably coupled to a source-available data visualization dashboard 318. One example of the source-available data visualization dashboard 318 is Kibana that is produced by Elasticsearch B.V. The distributed, multitenant-capable full-text search engine 315 is operably coupled to a cloud storage component 321. The cloud storage component 321 is operably coupled to an import worker 324 that is operably coupled through an A.P.I. to a life science journal database 327, such as Europe PubMed Central® (PMC) which provide access to open content and data. The distributed, multitenant-capable full-text search engine 315 is also operably coupled to a sync-worker 330. The A.P.I. 312 is operably coupled to a database manager and database 333. One example of the database manager 333 is MySql®, which is a relational database management system that uses SQL and primarily used to query and operate database systems by allowing handling, storing, modifying and deleting data in an organized way. The database manager and database 333 are operably coupled to the import worker 324 and the sync-worker 330 and an import worker 336 that is operably coupled through an A.P.I. to a business information database 339, that provides information on private and public companies, including content on investment and funding information, founding members and individuals in leadership positions, mergers and acquisitions, news, and industry trends. One example of the import worker 336 is Crunchbase®. The database manager 333 is operably coupled to a sales-enablement tool worker 341 and an affiliation parser worker 344. The database manager 333 is operably coupled to a queue worker 347 which is operably coupled to a clinical trial database 351 through an A.P.I. The database manager 333 is operably coupled to an organization name normalization worker 354. The A.P.I. 312 and the queue worker 347 are operably coupled to a storage system 357. The storage system 357 provide in-memory storage, and can provide a distributed, in-memory key-value database, cache and message broker, such as Redis®. The A.P.I. 312 is operably coupled to an object storage 360, which is A.P.I. compatible with the Amazon S3 cloud storage service and is capable of working with unstructured data such as photos, videos, log files, backups, and container images, such as Minio®.

The A.P.I. 312 is operably coupled to an email server 363 that sends emails, such as SendGrid®.

### Method Implementations

In the previous section, apparatus of the operation of an implementation was described. In this section, the particular methods performed by system 100, apparatus 200 and apparatus 300 of such an implementation are described by reference to a series of flowcharts.

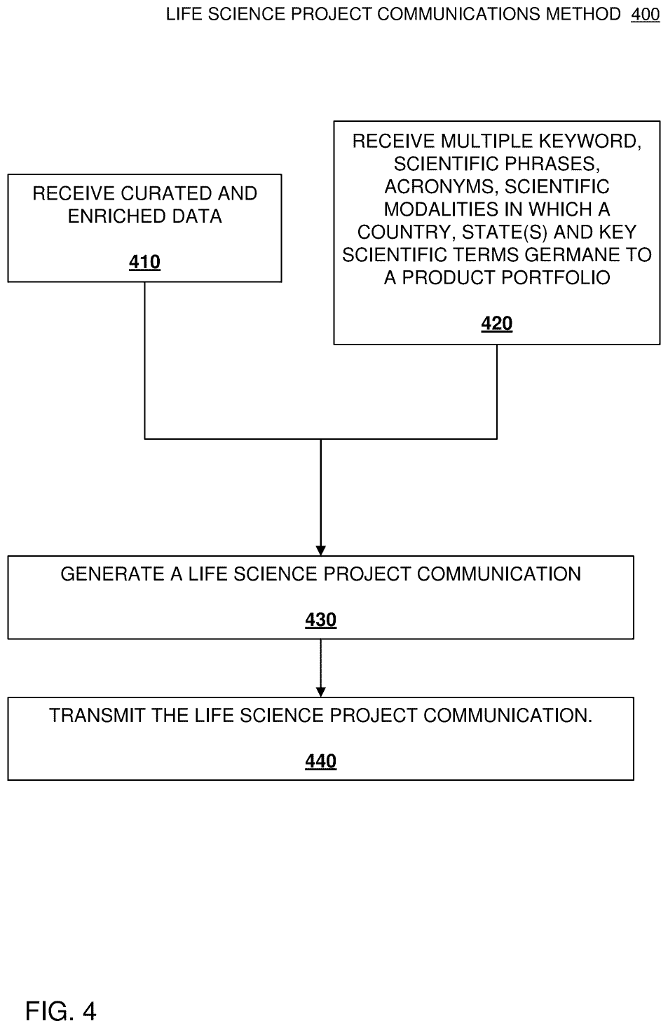

FIG. 4 is a flowchart of a method 400 to manage a life science project communication, according to an implementation. Method 400 provides a life science project communication.

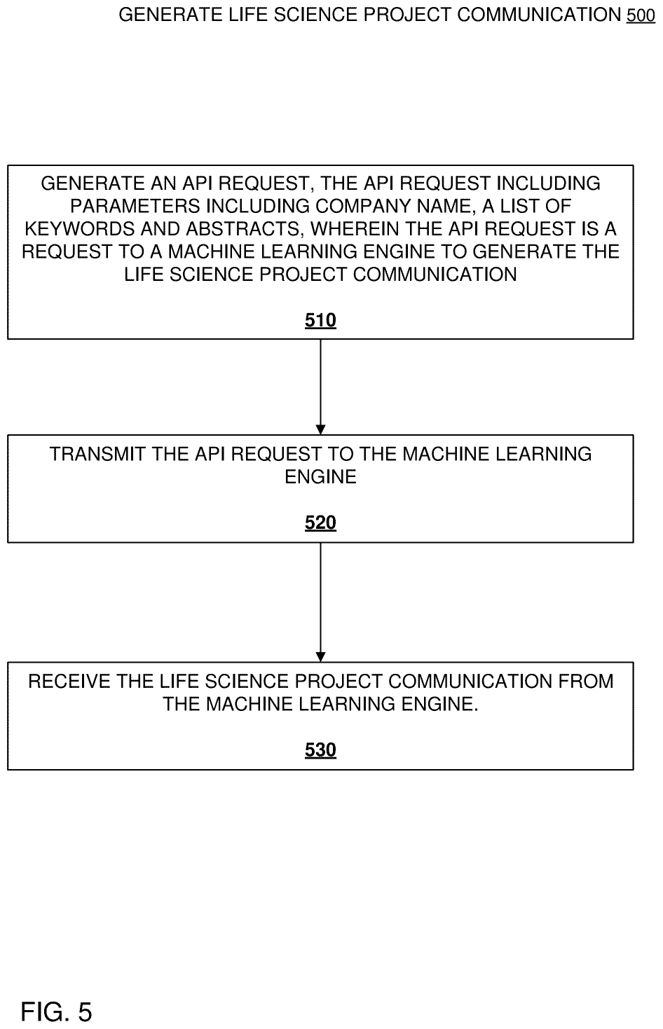

Method 400 includes receiving curated data and enriched data, at block 410. Method 400 also includes receiving multiple keywords, scientific phrases, acronyms, scientific modalities in which a country, state(s) and key scientific terms germane to a product portfolio are entered and saved, at block 420. Method 400 also includes generating a life science project communication, at block 430. One example of generating a life science project communication at block 430 is method 500 in FIG. 5. Method 400 also includes transmitting the life science project communication, at block 430.

FIG. 5 is a flowchart of a method 500 to generating the life science project communication, according to an implementation.

Method 500 is one example of generating the life science project communication 430 in FIG. 4. Method 500 also includes generating an API request, the API request including parameters including company name, a list of keywords and abstracts, wherein the API request is a request to a machine learning engine to generate the life science project communication, at block 510. Method 500 also includes transmitting the API request to the machine learning engine, at block 520. Method 500 also includes receiving the life science project communication from the machine learning engine, at block 530.

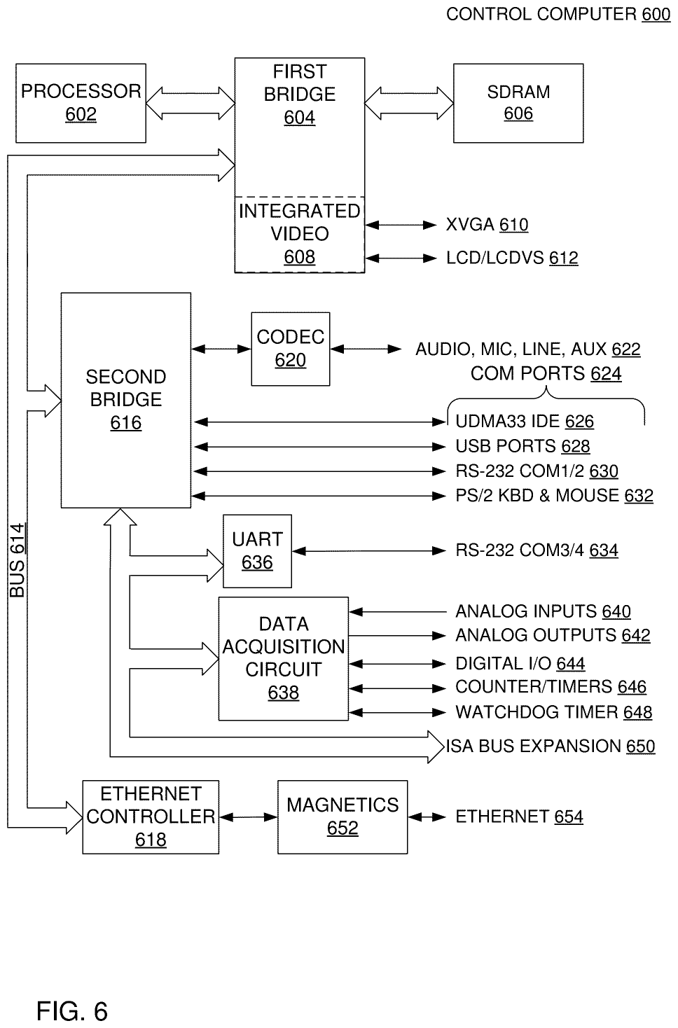

In some implementations, methods 400-500 are implemented as a sequence of computer instructions which, when executed by a processor, such as processor 602 in FIG. 6, processing unit 804 in FIG. 8 or main processor 902, cause the processor to perform the respective method. In other implementations, methods 400-500 are implemented as a computer-accessible medium having executable instructions capable of directing a processor, such as processor 602 in FIG. 6, processing unit 804 in FIG. 8 or main processor 902 to perform the respective method. In varying implementations, the medium is a magnetic medium, an electronic medium, or an optical medium.

### Machine Learning Processes

A machine learning trainer of the machine learning engine can be implemented using a number of different machine learning processes as described below. The machine learning trainer produces a trained neural network, which is also known as a model.

Machine learning is a subset of artificial intelligence that can learn from and make decisions and predictions based on data over time in response to the addition of new data and new results, in comparison to traditional systems that are relatively inflexibly designed to always provide a predetermined result from a specific set of data.

A machine learning system is a data-driven system rather than an algorithmic-based system. A machine learning system trains on a pre-defined data-set. Before training, the data is unlabeled or uncategorized.

There are four different categories for machine learning processes: Supervised learning, Unsupervised Learning, Semi-supervised learning and Reinforcement-Based Learning.

Supervised training is task driven to predict the next value that uses mapping between input and output, where the feedback provided to the agent is a correct set of actions for performing a task. In supervised learning, processes learn from labeled data using the supervised learning method in machine learning. This process involves the process receiving input data and the appropriate output labels. The goal is to teach the process to correctly predict labels for brand-new, untainted data. Processes like Decision Trees, Support Vector Machines, Random Forests, and Naive Bayes are examples of supervised learning processes. These processes can be applied to classification, regression, and time series forecasting tasks. In order to make predictions and derive useful insights from data, supervised learning is widely used in a variety of industries, including healthcare, finance, marketing, and image recognition.

Unsupervised training is data driven in order to identify clusters of data that have commonalities by automatically finding patterns and relationships in the dataset with no prior knowledge of the dataset or no prior training on the dataset. In Unsupervised learning, processes analyze unlabeled data in this machine learning method without using predetermined output labels. Finding patterns, relationships, or structures within the data is the aim. Unsupervised learning processes, in contrast to supervised learning, operate autonomously to unearth secret information and combine related data points. Clustering processes like K-means, hierarchical clustering, and DBSCAN, as well as dimensionality reduction techniques like PCA and t-SNE, are examples of popular unsupervised learning techniques.

Semi-supervised learning is a hybrid approach to machine learning that uses both labeled and unlabeled data for training. In order to enhance learning, it makes use of both a larger set of unlabeled data and a smaller amount of labeled data. The unlabeled data are supposed to offer extra context and information to improve the trained neural network's comprehension and functionality. Semi-supervised learning can get around the drawbacks of only using labeled data by effectively utilizing the unlabeled data. This strategy is especially helpful when getting labeled data requires a lot of resources or processing power.

In reinforcement-based learning, a machine learning process called reinforcement learning is developed in part as a reference to how people learn by making mistakes. In this scenario, an agent interacts with the environment and learns to choose the best course of action to maximize cumulative rewards. Based on its actions, the agent receives feedback in the form of rewards or penalties. Over time, the agent develops the ability to make decisions that produce the best results. Reinforcement-based learning makes it possible for machines to use a series of actions to accomplish long-term objectives, adapt to changing environments, and learn from their experiences. Reinforcement-based learning is an effective method for addressing challenging decision-making issues thanks to its dynamic learning approach. Reinforcement-based learning uses mapping between input and output and uses rewards and punishments as signals for positive and negative behavior. Reinforcement-based learning was pioneered by Richard Sutton. Examples of reinforcement learning include Q-learning that uses:

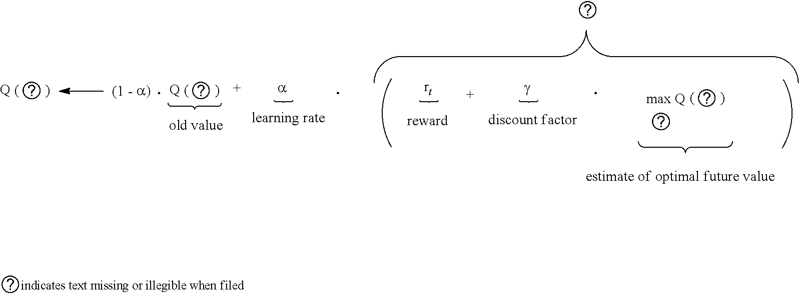

and SARSA (State-Action-Reward-State-Action) trained neural network tuning, in which all trained neural network weights are tuned, can be fine-tuned to adapt a machine learning trained neural network to new downstream tasks without retraining the entire machine learning trained neural network, such as by prefix tuning, which can be simplified as prompt tuning.

These four machine learning process categories are further divided into additional categories. These are the most popular supervised machine learning processes: decision tree, gradient boosting process and AdaBoosting process, KNN process, linear regression, logistic regression, Naive Bayes process, random forest process and SVM process. Unsupervised machine learning processes include K-means process.

Decision Tree. In a decision Tree process, in which a supervised learning process is used for problem classification, is one of the most widely used processes in machine learning. It does a good job of categorizing both categorical and continuous dependent variables. The population is split into two or more homogeneous sets using this process, depending on the most important features or independent variables.

Gradient boosting process and AdaBoosting process: These processes are used when massive loads of data have to be handled to make predictions with high accuracy. Boosting is an ensemble learning algorithm that combines the predictive power of several base estimators to improve robustness. In short, it combines multiple weak or average predictors to build a strong predictor.

KNN (K-Nearest Neighbors) process. In KNN, both classification and regression issues can be solved using this process. In KNN, a process that classifies any new cases by obtaining a majority vote from its k neighbors and then stores all of the existing cases. The class with which the case has the most in common is then given the assignment. This calculation is made using a distance function. The following factors should be taken into account before choosing the K Nearest Neighbors process. KNN requires a lot of computation resources. Normalizing variables is necessary to prevent process bias from higher range variables. Processing of the prior data is still required.

Linear regression process: By fitting the independent and dependent variables to a line, a relationship between them can be found in this process. The equation Y=a*X+b, also known as the regression line, describes this line. The sum of the squared distance differences between the data points and the regression line is minimized to obtain the coefficients a and b.

This equation reads as follows.

Y is the dependent variable.

Slope is a.

X is an unrelated variable.

Logistic Regression. Discrete values (typically binary values like 0/1) are estimated from a set of independent variables using logistic regression. By adjusting the data to a logic function, it aids in predicting the likelihood of an event. Additionally known as logic regression.

The Naive Bayes process. An assumption made by a Naive Bayes classifier is that the presence of one feature in a class has no bearing on the presence of any other features. When determining the likelihood of a specific result, a Naive Bayes classifier would take into account each of these features independently, even if these features are related to one another. Large datasets can benefit from using a Naive Bayesian trained neural network, which is simple to construct. It is known to perform better than even the most sophisticated classification techniques despite being simple.

Random Forests Process: A Random Forest is an arrangement of decision trees. Each tree is assigned a class and “votes” for that class in order to categorize a new object according to its attributes. Over all of the trees in the forest, the classification with the most votes is chosen by the forest.

The planting and growth of each tree is done as follows: If the training set contains N cases, then a random sample of N cases is selected. For growing the tree, this sample will serve as the training set.

If M input variables are present, then m.

The SVM process (Support Vector Machine): Plotting raw data as points in an n-dimensional space (where n is the number of features you have) is a technique used in the SVM process, a classification process. After that, each feature's value is associated with a specific coordinate, which facilitates the data's classification. The data can be divided into groups and plotted on a graph using lines known as classifiers.

K-Means. In K-means a process manages clustering issues by using unsupervised learning. Data sets are divided into a certain number of clusters (e.g. number K) in such a way that all the data points within a cluster are homogenous and heterogeneous from the data in other clusters. K-means creates clusters in the following ways: The K-means process selects k centroids, or points, for each cluster. With the closest centroids, each data point creates a cluster, i.e. clusters of K. From the current cluster members, it now generates new centroids. The closest distance for every data point is calculated using these new centroids. Up until the centroids stay the same, this process is repeated.

### Hardware and Operating Environments

FIG. 6 is a block diagram of a scientific project communication control computer 600 in which different implementations can be practiced. The scientific project communication control computer 600 includes a processor 602 (such as a Pentium III processor from Intel Corp. in this example) which includes dynamic and static ram and non-volatile program read-only-memory (not shown), a first bridge 604, operating memory 606 (SDRAM in this example). The first bridge 604 includes integrated video 608 that couples the scientific project communication control computer 600 to a XVGA communication path 610 and a LCD and/or LCDVS device 612.

The first bridge 604 is operably coupled to a bus 614 and the bus 614 is operably coupled to a second bridge 616 and an Ethernet® controller 618.

The second bridge 616 is operably coupled to a CODEC 620 and the CODEC 620 is coupled to an audio port 622. The second bridge 616 is operably coupled to communication ports 624 (e.g., UDMA IDE 626, USB port(s) 628, RS-232 630 COM1/2 and/or keyboard interface 632).

An RS-232 port 634 is coupled through a universal asynchronous receiver/transmitter (UART) 636 to the second bridge 616.

The second bridge 616 is operably coupled to a data acquisition circuit 638 with analog inputs 640 and outputs 642 and digital inputs and outputs 644.

In some implementations of the scientific project communication control computer 600, the data acquisition circuit 638 is also coupled to counter timer ports 646 and watchdog timer ports 648. In some implementations of the scientific project communication control computer 600, the second bridge 616 is operably coupled to an expansion bus 650.

In some implementations, the Ethernet® controller 618 is operably coupled to magnetics 652 which is operably coupled to an Ethernet® local area network 654

With proper digital amplifiers and analog signal conditioners, the scientific project communication control computer 600 can be programmed to drive apparatus 100, in a predetermined sequence.

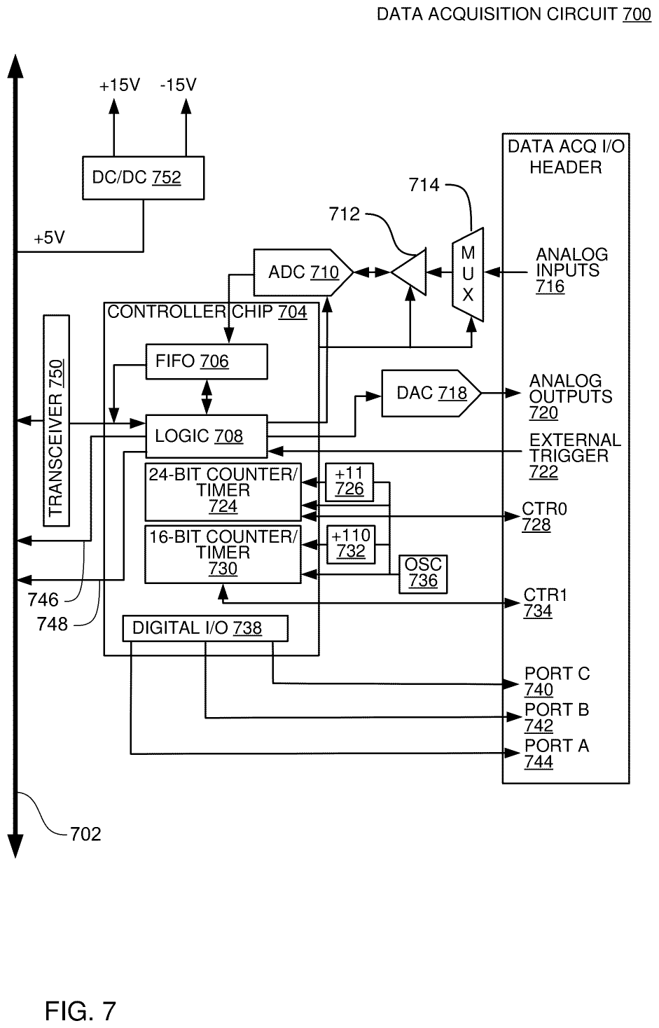

FIG. 7 is a block diagram of a data acquisition circuit 700 of a scientific project communication control computer, according to an implementation. The data acquisition circuit 700 is one example of the data acquisition circuit 638 in FIG. 6 above. Some implementations of the data acquisition circuit 700 provide 16-bit A/D performance with input voltage capability up to +/−10V, and programmable input ranges.

The data acquisition circuit 700 can include a bus 702, such as a conventional PC/104 bus. The data acquisition circuit 700 can be operably coupled to a controller chip 704. Some implementations of the controller chip 704 include an analog/digital first-in/first-out (FIFO) buffer 706 that is operably coupled to controller logic 708. In some implementations of the data acquisition circuit 700, the FIFO 706 receives signal data from and analog/digital converter (ADC) 710, which exchanges signal data with a programmable gain amplifier 712, which receives data from a multiplexer 714, which receives signal data from analog inputs 716.

In some implementations of the data acquisition circuit 700, the controller logic 708 sends signal data to the ADC 710 and a digital/analog converter (DAC) 718. The DAC 718 sends signal data to analog outputs. In some implementations of the data acquisition circuit 700, the controller logic 708 receives signal data from an external trigger 722.

In some implementations of the data acquisition circuit 700, the controller chip 704 includes a digital input/output (I/O) component 738 that sends digital signal data to computer output ports.

In some implementations of the data acquisition circuit 700, the controller logic 708 sends signal data to the bus 702 via a control line 746 and an interrupt line 748. In some implementations of the data acquisition circuit 700, the controller logic 708 exchanges signal data to the bus 702 via a transceiver 750.

Some implementations of the data acquisition circuit 700 include 12-bit D/A channels, programmable digital I/O lines, and programmable counter/timers. Analog circuitry can be placed away from the high-speed digital logic to ensure low-noise performance for important applications. Some implementations of the data acquisition circuit 700 are fully supported by operating systems that can include, but are not limited to, DOS™, Linux™, RTLinux™, QNX™, Windows 98/NT/2000/XP/CE™, Forth™, and VxWorks™ to simplify application development.

FIG. 8 is a block diagram of a hardware and operating environment 800 in which different implementations can be practiced. The description of FIG. 8 provides an overview of computer hardware and a suitable computing environment in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

Computer 802 includes a processing unit 804, commercially available from Intel, Motorola, Cyrix and others. The computer 802 also includes system memory 806 that includes random-access memory RAM 808 and read-only memory ROM 810. The computer 802 also includes one or more mass storage devices 812; and a system bus 814 that operatively couples various system components to the processing unit 804. The RAM 808 and ROM 810, and mass storage devices 812, are types of computer-accessible media. Mass storage devices 812 are more specifically types of nonvolatile computer-accessible media and can include one or more hard disk drives, floppy disk drives, optical disk drives, and tape cartridge drives. The processing unit 804 executes computer programs stored on the computer-accessible media.

Computer 802 can be communicatively connected to the Internet 816 via a communication device, such as modem 818. Internet 816 connectivity is well known within the art. In one implementation, the modem 818 responds to communication drivers to connect to the Internet 816 via what is known in the art as a “dial-up connection.” In another implementation, the communication device is an Ethernet® or network adapter 820 connected to a local-area network (LAN) 822 that itself is connected to the Internet 816 via what is known in the art as a “direct connection” (e.g., T1 line, etc.).

A user enters commands and information into the computer 802 through input devices such as a keyboard (not shown) or a pointing device (not shown). The keyboard permits entry of textual information into computer 802, as known within the art, and implementations are not limited to any particular type of keyboard. Pointing device permits the control of the screen pointer provided by a graphical user interface (GUI) of operating systems such as versions of Microsoft Windows®. Implementations are not limited to any particular pointing device. Such pointing devices include mice, touch pads, trackballs, remote controls and point sticks. Other input devices (not shown) can include a microphone, joystick, game pad, satellite dish, scanner, or the like.

In some implementations, computer 802 is operatively coupled to a display device 824. Display device 824 is connected to the system bus 814 through a video adapter 826. Display device 824 permits the display of information, including computer, video and other information, for viewing by a user of the computer. Implementations are not limited to any particular display device 824. Such display devices include cathode ray tube (CRT) displays (monitors), as well as flat panel displays such as liquid crystal displays (LCD's). In addition to a monitor, computers typically include other peripheral input/output devices such as printers (not shown). Speakers (not shown) provide audio output of signals. Speakers are also connected to the system bus 814.

Computer 802 can be operated using at least one operating system to provide a graphical user interface (GUI) including a user-controllable pointer. Computer 802 can have at least one web browser application program executing within at least one operating system, to permit users of computer 802 to access intranet or Internet world-wide-web pages as addressed by Universal Resource Locator (URL) addresses. Examples of browser application programs include Netscape Navigator® and Microsoft Internet Explorer®.

The computer 802 can operate in a networked environment using logical connections to one or more remote computers, such as remote computer 828. These logical connections are achieved by a communication device coupled to, or a part of, the computer 802. Implementations are not limited to a particular type of communications device. The remote computer 828 can be another computer, a server, a router, a network PC, a client, a peer device or other common network node. The logical connections depicted in FIG. 8 include the local-area network (LAN) 822 and a wide-area network (WAN). Such networking environments are commonplace in offices, enterprise-wide computer networks, intranets and the Internet.

When used in a LAN-networking environment, the computer 802 and remote computer 828 are connected to the local network 822 through network interfaces or adapters 820, which is one type of communications device 818. When used in a conventional WAN-networking environment, the computer 802 and remote computer 828 communicate with a WAN through modems. The modems, which can be internal or external, is connected to the system bus 814. In a networked environment, program modules depicted relative to the computer 802, or portions thereof, can be stored in the remote computer 828.

Computer 802 also includes an operating system 830 that can be stored on the RAM 808 and ROM 810, and/or mass storage device 812, and is and executed by the processing unit 804. Examples of operating systems include Microsoft Windows®, Apple MacOS®, Linux®, UNIX®, providing capability for supporting application programs 832 using, for example, code modules written in the C++® computer programming language. Examples are not limited to any particular operating system, however, and the construction and use of such operating systems are well known within the art.

Instructions can be stored via the mass storage devices 812 or system memory 806, including one or more application programs 832, other program modules 834 and program data 836.

Computer 802 also includes power supply. Each power supply can be a battery.

Some implementations include computer instructions that can be implemented in instructions or the instructions stored via the mass storage devices 812 or system memory 806 in FIG. 8.

FIG. 9 is a block diagram of a scientific project communication control mobile device 900, according to an implementation. The scientific project communication control mobile device 900 includes a number of components such as a main processor 902 that controls the overall operation of the scientific project communication control mobile device 900. Communication functions, including data and voice communications, are performed through a communication subsystem 904. The communication subsystem 904 receives messages from and sends messages to a wireless network 906. In this exemplary implementation of the scientific project communication control mobile device 900, the communication subsystem 904 is configured in accordance with the Global System for Mobile Communication (GSM), General Packet Radio Services (GPRS) standards, 3G, 4G, 5G and/or 6G. It will also be understood by persons skilled in the art that the implementations described herein are intended to use any other suitable standards that are developed in the future. The wireless link connecting the communication subsystem 904 with the wireless network 906 represents one or more different Radio Frequency (RF) channels, operating according to defined protocols specified for 4G or 5G communications. With newer network protocols, these channels are capable of supporting both circuit switched voice communications and packet switched data communications.

Although the wireless network 906 associated with scientific project communication control mobile device 900 is a GSM/GPRS, 3G, 4G, 5G and/or 6G wireless network in one exemplary implementation, other wireless networks may also be associated with the scientific project communication control mobile device 900 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks, 3G, 4G, 5G and/or 6G. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems.

The main processor 902 also interacts with additional subsystems such as a Random Access Memory (RAM) 908, a flash memory 910, a display 912, an auxiliary input/output (I/O) subsystem 914, a data port 916, a keyboard 918, a speaker 920, a microphone 922, short-range communications 924 and other device subsystems 926.

Some of the subsystems of the scientific project communication control mobile device 900 perform communication-related functions, whereas other subsystems may provide “resident” or on-device functions. By way of example, the display 912 and the keyboard 918 may be used for both communication-related functions, such as entering a text message for transmission over the wireless network 906, and device-resident functions such as a calculator or task list.

The scientific project communication control mobile device 900 can send and receive communication signals over the wireless network 906 after required network registration or activation procedures have been completed. Network access is associated with a subscriber or user of the scientific project communication control mobile device 900. To identify a subscriber, the scientific project communication control mobile device 900 requires a SIM/RUIM card 928 (i.e. Subscriber Identity Module or a Removable User Identity Module) to be inserted into a SIM/RUIM interface 930 in order to communicate with a network. The SIM card or RUIM 928 is one type of a conventional “smart card” that can be used to identify a subscriber of the scientific project communication control mobile device 900 and to customize the scientific project communication control mobile device 900, among other aspects. Without the SIM card 928, the scientific project communication control mobile device 900 is not fully operational for communication with the wireless network 906. By inserting the SIM card/RUIM 928 into the SIM/RUIM interface 930, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 928 includes a processor and memory for storing information. Once the SIM card/RUIM 928 is inserted into the SIM/RUIM interface 930, it is coupled to the main processor 902. In order to identify the subscriber, the SIM card/RUIM 392 can include some user parameters such as an International Mobile Subscriber Identity (IMSI). An advantage of using the SIM card/RUIM 928 is that a subscriber is not necessarily bound by any single physical mobile device. The SIM card/RUIM 928 may store additional subscriber information for a mobile device as well, including datebook (or calendar) information and recent call information. Alternatively, user identification information can also be programmed into the flash memory 910.

The scientific project communication control mobile device 900 is a battery-powered device and includes a battery interface 932 for receiving one or more rechargeable batteries 934. In one or more implementations, the battery 934 can be a smart battery with an embedded microprocessor. The battery interface 932 is coupled to a regulator 936, which assists the battery 934 in providing power V+ to the scientific project communication control mobile device 900. Although current technology makes use of a battery, future technologies such as micro fuel cells may provide the power to the scientific project communication control mobile device 900.

The scientific project communication control mobile device 900 also includes an operating system 938 and software components 940 to 952 which are described in more detail below. The operating system 938 and the software components 940 to 952 that are executed by the main processor 902 are typically stored in a persistent store such as the flash memory 910, which may alternatively be a read-only memory (ROM) or similar storage element (not shown). Those skilled in the art will appreciate that portions of the operating system 938 and the software components 940 to 952, such as specific device applications, or parts thereof, may be temporarily loaded into a volatile store such as the RAM 908. Other software components can also be included.

The subset of software components 940 that control basic device operations, including data and voice communication applications, will normally be installed on the scientific project communication control mobile device 900 during its manufacture. Other software applications include a message application 942 that can be any suitable software program that allows a user of the scientific project communication control mobile device 900 to send and receive electronic messages. Various alternatives exist for the message application 942 as is well known to those skilled in the art. Messages that have been sent or received by the user are typically stored in the flash memory 910 of the scientific project communication control mobile device 900 or some other suitable storage element in the scientific project communication control mobile device 900. In one or more implementations, some of the sent and received messages may be stored remotely from the scientific project communication control mobile device 900 such as in a data store of an associated host system with which the scientific project communication control mobile device 900 communicates.

The software applications can further include a device state module 944, a Personal Information Manager (PIM) 946, and other suitable modules (not shown). The device state module 944 provides persistence, i.e. the device state module 945 ensures that important device data is stored in persistent memory, such as the flash memory 910, so that the data is not lost when the scientific project communication control mobile device 900 is turned off or loses power.

The PIM 946 includes functionality for organizing and managing data items of interest to the user, such as, but not limited to, e-mail, contacts, calendar events, voice mails, appointments, and task items. A PIM application has the ability to send and receive data items via the wireless network 906. PIM data items may be seamlessly integrated, synchronized, and updated via the wireless network 906 with the mobile device subscriber's corresponding data items stored and/or associated with a host computer system. This functionality creates a mirrored host computer on the scientific project communication control mobile device 900 with respect to such items. This can be particularly advantageous when the host computer system is the mobile device subscriber's office computer system.

The scientific project communication control mobile device 900 also includes a connect module 948, and an IT policy module 950. The connect module 948 implements the communication protocols that are required for the scientific project communication control mobile device 900 to communicate with the wireless infrastructure and any host system, such as an enterprise system, with which the scientific project communication control mobile device 900 is authorized to interface.

The connect module 948 includes a set of APIs that can be integrated with the scientific project communication control mobile device 900 to allow the scientific project communication control mobile device 900 to use any number of services associated with the enterprise system. The connect module 948 allows the scientific project communication control mobile device 900 to establish an end-to-end secure, authenticated communication pipe with the host system. A subset of applications for which access is provided by the connect module 948 can be used to pass IT policy commands from the host system to the scientific project communication control mobile device 900. This can be done in a wireless or wired manner. These instructions can then be passed to the IT policy module 950 to modify the configuration of the scientific project communication control mobile device 900. Alternatively, in some cases, the IT policy update can also be done over a wired connection.

The IT policy module 950 receives IT policy data that encodes the IT policy. The IT policy module 950 then ensures that the IT policy data is authenticated by the scientific project communication control mobile device 900. The IT policy data can then be stored in the flash memory 910 in its native form. After the IT policy data is stored, a global notification can be sent by the IT policy module 950 to all of the applications residing on the scientific project communication control mobile device 900. Applications for which the IT policy may be applicable then respond by reading the IT policy data to look for IT policy rules that are applicable.

The IT policy module 950 can include a parser 952, which can be used by the applications to read the IT policy rules. In some cases, another module or application can provide the parser. Grouped IT policy rules, described in more detail below, are retrieved as byte streams, which are then sent (recursively) into the parser to determine the values of each IT policy rule defined within the grouped IT policy rule. In one or more implementations, the IT policy module 950 can determine which applications are affected by the IT policy data and send a notification to only those applications. In either of these cases, for applications that are not being executed by the main processor 902 at the time of the notification, the applications can call the parser or the IT policy module 950 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 950 sends an acknowledgement back to the host system to indicate that the IT policy data was received and successfully applied.

Other types of software applications can also be installed on the scientific project communication control mobile device 900. These software applications can be third party applications, which are added after the manufacture of the scientific project communication control mobile device 900. Examples of third party applications include games, calculators, utilities, etc.

The additional applications can be loaded onto the scientific project communication control mobile device 900 through at least one of the wireless network 906, the auxiliary I/O subsystem 914, the data port 916, the short-range communications subsystem 924, or any other suitable device subsystem 924. This flexibility in application installation increases the functionality of the scientific project communication control mobile device 900 and may provide enhanced on-device functions, communication-related functions, or both. For example, secure communication applications may enable electronic commerce functions and other such financial transactions to be performed using the scientific project communication control mobile device 900.

The data port 916 enables a subscriber to set preferences through an external device or software application and extends the capabilities of the scientific project communication control mobile device 900 by providing for information or software downloads to the scientific project communication control mobile device 900 other than through a wireless communication network. The alternate download path may, for example, be used to load an encryption key onto the scientific project communication control mobile device 900 through a direct and thus reliable and trusted connection to provide secure device communication.

The data port 916 can be any suitable port that enables data communication between the scientific project communication control mobile device 900 and another computing device. The data port 916 can be a serial or a parallel port. In some instances, the data port 916 can be a USB port that includes data lines for data transfer and a supply line that can provide a charging current to charge the battery 934 of the scientific project communication control mobile device 900.

The short-range communications subsystem 924 provides for communication between the scientific project communication control mobile device 900 and different systems or devices, without the use of the wireless network 906. For example, the subsystem 924 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 904 and input to the main processor 902. The main processor 902 will then process the received signal for output to the display 912 or alternatively to the auxiliary I/O subsystem 914. A subscriber may also compose data items, such as e-mail messages, for example, using the keyboard 918 in conjunction with the display 912 and possibly the auxiliary I/O subsystem 914. The auxiliary subsystem 914 may include devices such as: a touch screen, mouse, track ball, infrared fingerprint detector, or a roller wheel with dynamic button pressing capability. The keyboard 918 is preferably an alphanumeric keyboard and/or telephone-type keypad. However, other types of keyboards may also be used. A composed item may be transmitted over the wireless network 906 through the communication subsystem 904.

For voice communications, the overall operation of the scientific project communication control mobile device 900 is substantially similar, except that the received signals are output to the speaker 920, and signals for transmission are generated by the microphone 922. Alternative voice or audio I/O subsystems, such as a voice message recording subsystem, can also be implemented on the scientific project communication control mobile device 900. Although voice or audio signal output is accomplished primarily through the speaker 920, the display 912 can also be used to provide additional information such as the identity of a calling party, duration of a voice call, or other voice call related information.

In some implementations, the scientific project communication control mobile device 900 includes a camera 954 receiving a plurality of images 956 from and examining pixel-values of the plurality of images 956.

### CONCLUSION

A life science project communication system is described. A technical effect of the life science project communication system is generation and transmission of a life science project communication. Although specific implementations are illustrated and described herein, it will be appreciated by those of ordinary skill in the art that any arrangement which is calculated to achieve the same purpose may be substituted for the specific implementations shown. This application is intended to cover any adaptations or variations. For example, although described in procedural terms, one of ordinary skill in the art will appreciate that implementations can be made in objected-oriented or any other design architecture that provides the required function.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future scientific databases, different machine learning processes and new transmission mediums.

The terminology used in this application meant to include all application programming interfaces and programming languages and alternate technologies which provide the same functionality as described herein. Some implementations of the apparatus in FIG. 1-FIG. 3 and FIG. 6-FIG. 9 and the methods in FIG. 4 and FIG. 5 use Nest.js (node.js), MSSQL, ElasticSearch, ASP.NET (.NET 6), Next.js (React), GitLab (CI/CD), Docker, K3s (Kubernetes), AWS (S3), KeyCloak (Auth), and/or mobx.

1. An apparatus operable to manage a life science project communication, the apparatus comprising:
a microprocessor;
a first receiver being operably coupled to the microprocessor and having computer instructions that when executed receive a curated data and an enriched data;
a second receiver being operably coupled to the microprocessor and having computer instructions that when executed receive multiple keywords, scientific phrases, acronyms, scientific modalities, a country, state(s) and key scientific terms that are germane to a product portfolio are entered and saved;
a generator of the life science project communication operably coupled to the microprocessor and having computer instructions that when executed generate the life science project communication from the curated data and the enriched data and from the multiple keywords, the scientific phrases, the acronyms, the scientific modalities, the country, the state(s) and the key scientific terms that are germane to the product portfolio,
wherein the generator generates an application program (A.P.I.) request to a machine learning engine, the A.P.I. request having parameters that include a company name, a list of keywords and an abstract, wherein the A.P.I. request is a request to a machine learning engine to generate the life science project communication, the generator transmits the A.P.I. request to the machine learning engine, and the generator receives the life science project communication from the machine learning engine,
wherein the machine learning engine accesses a neural network model in a semiconductor memory that is trained in one of a plurality of machine learning processes that include supervised machine learning processes, unsupervised machine learning processes, semi-supervised machine learning processes and reinforcement-based machine learning processes, wherein the supervised machine learning processes are task driven to predict a next value that uses mapping between an input and an output, where a feedback provided to a human agent is a correct set of actions for performing a task,
wherein the supervised machine learning processes learn from a labeled data using a supervised learning process that includes receiving input data and a plurality of appropriate output labels, to teach the supervised learning process to correctly predict labels for brand-new, untainted data, the supervised learning processes including decision trees, support vector machines, random forests, and naive bayes, these processes are applied to classification, regression, and time series forecasting tasks, in order to make predictions and derive useful insights from data,
wherein the unsupervised machine learning processes is data driven in order to identify clusters of data that have commonalities by automatically finding patterns and relationships in a dataset with no prior knowledge of the dataset or no prior training on the dataset, in the unsupervised machine learning processes, processes analyze unlabeled data without using predetermined output labels, finding patterns, relationships, or structures within the data, in which the unsupervised machine learning processes operate autonomously to unearth secret information and combine related data points, clustering processes including k-means, hierarchical clustering, as well as dimensionality reduction techniques,
wherein the semi-supervised machine learning processes is a hybrid process that uses both labeled and unlabeled data for training, in order to enhance learning, which uses both a larger set of unlabeled data and a smaller amount of labeled data,
wherein the reinforcement-based machine learning processes receives feedback in a format of rewards or penalties, the human agent develops an ability to make decisions that produce the best results, including q-learning reinforcement machine learning processes include that includes state-action-reward-state-action and trained neural network tuning, in which all trained neural network weights are tuned, and are fine-tuned to adapt a machine learning trained neural network to new downstream tasks without retraining the machine learning trained neural network, the retraining including prefix tuning, which are simplified as prompt tuning,
wherein the supervised machine learning processes include decision tree machine learning processes, gradient boosting machine learning processes, boosting machine learning processes, k-nearest neighbors machine learning processes, linear regression machine learning processes, logistic regression machine learning processes, naive bayes machine learning processes, random forest process and support vector machine learning processes,
wherein the unsupervised machine learning processes include k-means machine learning processes, decision tree machine learning processes in which a supervised machine learning processes is used for problem classification which categorizes both categorical and continuous dependent variables, and data is split into two or more homogeneous sets, gradient boosting machine learning processes and boosting machine learning processes, wherein the boosting machine learning processes include an ensemble of learning processes that combines a predictive power of several base estimators to improve robustness, which combines multiple weak or average predictors to build a strong predictor,
wherein the k-nearest neighbors machine learning processes, both classification and regression issues are solved by a process that classifies any new cases by obtaining a majority vote from k neighbors and then stores all of a plurality of existing cases, the class with which the case has the most in common is then given an assignment, in which a plurality of factors are taken into account before choosing a plurality of k-nearest neighbors process,
wherein the linear regression machine learning processes fit independent and dependent variables to a line, a relationship between the lines is calculated as a regression line
wherein the logistic regression machine learning processes a plurality of discrete values are estimated from a set of independent variables using logistic regression, by adjusting the data to a logic function, predicts a likelihood of an event,
wherein the random forests machine learning processes, a random forest is an arrangement of decision trees, each tree is assigned a class and votes for that class in order to categorize a new object according to its attributes, over all of the trees in the random forest, the classification with the most votes is chosen by the random forest,
wherein the support vector machine learning processes plots raw data as points in an n-dimensional space, where n is a plurality of features, a classification process, after that, each feature's value is associated with a specific coordinate, which facilitates classification of the data, the data are divided into groups and plotted on a graph using lines known as classifiers,
wherein the k-means machine learning processes manages clustering issues by using unsupervised learning, data sets are divided into a certain number of clusters, in such a way that all the data points within a cluster are homogenous and heterogeneous from the data in other clusters, k-means creates clusters wherein the k-means process selects k centroids, or points, for each cluster, with the closest centroids, each data point creates a cluster from a plurality of member of the current cluster, which generates new centroids, a closest distance for every data point is calculated using the new centroids, up until the centroids stay the same, and
a transmitter being operably coupled to the microprocessor and having computer instructions that when executed transmit the life science project communication.

2. The apparatus of claim 1, wherein the first receiver further comprises computer instructions that when executed receive the curated data and the enriched data from a National Institutes of Health (NIH) database, a National Science Foundation (NSF) database, a Canadian Institutes of Health Research (CIHR) database, a foundation database, a venture capital organization database, a scientific conference database, and a publications database.

3. The apparatus of claim 1, wherein data from the curated data and the enriched data is missing contact details, wherein the missing contact details include address, phone, and email address.

4. An apparatus to manage a life science project communication, the apparatus comprising:
a first receiver being operable to receive a curated data and an enriched data;
a second receiver being operably coupled to the first receiver and being operable to receive multiple keywords, scientific phrases, acronyms, scientific modalities, a country, state(s) and key scientific terms that are germane to a product portfolio are entered and saved;
a generator of the life science project communication operably coupled to the second receiver and being operable to generate the life science project communication from the curated data and the enriched data and from the multiple keywords, the scientific phrases, the acronyms, the scientific modalities, in which the country, the state(s) and the key scientific terms that are germane to the product portfolio,
wherein the generator generates an application program (A.P.I.) request to a machine learning engine, the A.P.I. request having parameters that include a company name, a list of keywords and an abstract, wherein the A.P.I. request is a request to a machine learning engine to generate the life science project communication, the generator transmits the A.P.I. request to the machine learning engine, and the generator receives the life science project communication from the machine learning engine,
wherein the machine learning engine accesses a neural network model in a semiconductor memory that is trained in one of a plurality of machine learning processes that include supervised machine learning processes, unsupervised machine learning processes, semi-supervised machine learning processes and reinforcement-based machine learning processes, wherein the supervised machine learning processes are task driven to predict a next value that uses mapping between an input and an output, where a feedback provided to a human agent is a correct set of actions for performing a task, wherein the supervised machine learning processes learn from a labeled data using a supervised learning process that includes receiving input data and a plurality of appropriate output labels, to teach the supervised learning process to correctly predict labels for brand-new, untainted data, the supervised learning processes including decision trees, support vector machines, random forests, and naive bayes, these processes are applied to classification, regression, and time series forecasting tasks, in order to make predictions and derive useful insights from data, supervised learning is widely used in a variety of industries, including healthcare, finance, marketing, and image recognition,
wherein the unsupervised machine learning processes is data driven in order to identify clusters of data that have commonalities by automatically finding patterns and relationships in a dataset with no prior knowledge of the dataset or no prior training on the dataset, in the unsupervised machine learning processes, processes analyze unlabeled data without using predetermined output labels, finding patterns, relationships, or structures within the data, in which the unsupervised machine learning processes operate autonomously to unearth secret information and combine related data points, clustering processes including k-means, hierarchical clustering, as well as dimensionality reduction techniques,
wherein the semi-supervised machine learning processes is a hybrid process that uses both labeled and unlabeled data for training, in order to enhance learning, which uses both a larger set of unlabeled data and a smaller amount of labeled data,
wherein the reinforcement-based machine learning processes receives feedback in a format of rewards or penalties, the human agent develops an ability to make decisions that produce the best results, including q-learning reinforcement machine learning processes include that includes state-action-reward-state-action and trained neural network tuning, in which all trained neural network weights are tuned, and are fine-tuned to adapt a machine learning trained neural network to new downstream tasks without retraining the machine learning trained neural network, the retraining including prefix tuning, which are simplified as prompt tuning,
wherein the supervised machine learning processes include decision tree machine learning processes, gradient boosting machine learning processes, boosting machine learning processes, k-nearest neighbors machine learning processes, linear regression machine learning processes, logistic regression machine learning processes, naive bayes machine learning processes, random forest process and support vector machine learning processes,
wherein the unsupervised machine learning processes include k-means machine learning processes, decision tree machine learning processes in which a supervised machine learning processes is used for problem classification which categorizes both categorical and continuous dependent variables, and data is split into two or more homogeneous sets, gradient boosting machine learning processes and boosting machine learning processes, wherein the boosting machine learning processes include an ensemble of learning processes that combines a predictive power of several base estimators to improve robustness, which combines multiple weak or average predictors to build a strong predictor,
wherein the k-nearest neighbors machine learning processes, both classification and regression issues are solved by a process that classifies any new cases by obtaining a majority vote from k neighbors and then stores all of a plurality of existing cases, the class with which the case has the most in common is then given an assignment, in which a plurality of factors are taken into account before choosing a plurality of k-nearest neighbors process,
wherein the linear regression machine learning processes fit independent and dependent variables to a line, a relationship between the lines is calculated as a regression line
wherein the logistic regression machine learning processes a plurality of discrete values are estimated from a set of independent variables using logistic regression, by adjusting the data to a logic function, predicts a likelihood of an event,
wherein the random forests machine learning processes, a random forest is an arrangement of decision trees, each tree is assigned a class and votes for that class in order to categorize a new object according to its attributes, over all of the trees in the random forest, the classification with the most votes is chosen by the random forest,
wherein the support vector machine learning processes plots raw data as points in an n-dimensional space, where n is a plurality of features, a classification process, after that, each feature's value is associated with a specific coordinate, which facilitates classification of the data, the data are divided into groups and plotted on a graph using lines known as classifiers,
wherein the k-means machine learning processes manages clustering issues by using unsupervised learning, data sets are divided into a certain number of clusters, in such a way that all the data points within a cluster are homogenous and heterogeneous from the data in other clusters, k-means creates clusters wherein the k-means process selects k centroids, or points, for each cluster, with the closest centroids, each data point creates a cluster from a plurality of member of the current cluster, which generates new centroids, a closest distance for every data point is calculated using the new centroids, up until the centroids stay the same, and
a transmitter being operably coupled to the generator and being operable to transmit the life science project communication.

5. The apparatus of claim 4, wherein the first receiver is further operable to receive the curated data and the enriched data from a National Institutes of Health (NIH) database, a National Science Foundation (NSF) database, a Canadian Institutes of Health Research (CIHR) database, a foundation database, a venture capital organization database, a scientific conference database, and a publications database.

6. The apparatus of claim 4, wherein data from the curated data and the enriched data is missing contact details, wherein the missing contact details include address, phone, and email address.

7. A system to manage a life science project communication, the system comprising:
a first receiver and being operable to receive a curated data and an enriched data;
a second receiver being operably coupled to the first receiver and being operable to receive multiple keywords, scientific phrases, acronyms, scientific modalities, a country, state(s) and key scientific terms that are germane to a product portfolio are entered and saved;
a generator of the life science project communication operably coupled to the second receiver and being operable to generate the life science project communication from the curated data and the enriched data and from the multiple keywords, the scientific phrases, the acronyms, the scientific modalities, in which the country, the state(s) and the key scientific terms that are germane to the product portfolio,
wherein the generator generates an application program (A.P.I.) request to a machine learning engine, the A.P.I. request having parameters that include a company name, a list of keywords and an abstract, wherein the A.P.I. request is a request to a machine learning engine to generate the life science project communication, the generator transmits the A.P.I. request to the machine learning engine, and the generator receives the life science project communication from the machine learning engine,
wherein the machine learning engine accesses a neural network model in a semiconductor memory that is trained in one of a plurality of machine learning processes that include supervised machine learning processes, unsupervised machine learning processes, semi-supervised machine learning processes and reinforcement-based machine learning processes, wherein the supervised machine learning processes are task driven to predict a next value that uses mapping between an input and an output, where a feedback provided to a human agent is a correct set of actions for performing a task, wherein the supervised machine learning processes learn from a labeled data using a supervised learning process that includes receiving input data and a plurality of appropriate output labels, to teach the supervised learning process to correctly predict labels for brand-new, untainted data, the supervised learning processes including decision trees, support vector machines, random forests, and naive bayes, these processes are applied to classification, regression, and time series forecasting tasks, in order to make predictions and derive useful insights from data, supervised learning is widely used in a variety of industries, including healthcare, finance, marketing, and image recognition,
wherein the unsupervised machine learning processes is data driven in order to identify clusters of data that have commonalities by automatically finding patterns and relationships in a dataset with no prior knowledge of the dataset or no prior training on the dataset, in the unsupervised machine learning processes, processes analyze unlabeled data without using predetermined output labels, finding patterns, relationships, or structures within the data, in which the unsupervised machine learning processes operate autonomously to unearth secret information and combine related data points, clustering processes including k-means, hierarchical clustering, as well as dimensionality reduction techniques,
wherein the semi-supervised machine learning processes is a hybrid process that uses both labeled and unlabeled data for training, in order to enhance learning, which uses both a larger set of unlabeled data and a smaller amount of labeled data,
wherein the reinforcement-based machine learning processes receives feedback in a format of rewards or penalties, the human agent develops an ability to make decisions that produce the best results, including q-learning reinforcement machine learning processes include that includes state-action-reward-state-action and trained neural network tuning, in which all trained neural network weights are tuned, and are fine-tuned to adapt a machine learning trained neural network to new downstream tasks without retraining the machine learning trained neural network, the retraining including prefix tuning, which are simplified as prompt tuning,
wherein the supervised machine learning processes include decision tree machine learning processes, gradient boosting machine learning processes, boosting machine learning processes, k-nearest neighbors machine learning processes, linear regression machine learning processes, logistic regression machine learning processes, naive bayes machine learning processes, random forest process and support vector machine learning processes,
wherein the unsupervised machine learning processes include k-means machine learning processes, decision tree machine learning processes in which a supervised machine learning processes is used for problem classification which categorizes both categorical and continuous dependent variables, and data is split into two or more homogeneous sets, gradient boosting machine learning processes and boosting machine learning processes, wherein the boosting machine learning processes include an ensemble of learning processes that combines a predictive power of several base estimators to improve robustness, which combines multiple weak or average predictors to build a strong predictor,
wherein the k-nearest neighbors machine learning processes, both classification and regression issues are solved by a process that classifies any new cases by obtaining a majority vote from k neighbors and then stores all of a plurality of existing cases, the class with which the case has the most in common is then given an assignment, in which a plurality of factors are taken into account before choosing a plurality of k-nearest neighbors process,
wherein the linear regression machine learning processes fit independent and dependent variables to a line, a relationship between the lines is calculated as a regression line
wherein the logistic regression machine learning processes a plurality of discrete values are estimated from a set of independent variables using logistic regression, by adjusting the data to a logic function, predicts a likelihood of an event,
wherein the random forests machine learning processes, a random forest is an arrangement of decision trees, each tree is assigned a class and votes for that class in order to categorize a new object according to its attributes, over all of the trees in the random forest, the classification with the most votes is chosen by the random forest,
wherein the support vector machine learning processes plots raw data as points in an n-dimensional space, where n is a plurality of features, a classification process, after that, each feature's value is associated with a specific coordinate, which facilitates classification of the data, the data are divided into groups and plotted on a graph using lines known as classifiers,
wherein the k-means machine learning processes manages clustering issues by using unsupervised learning, data sets are divided into a certain number of clusters, in such a way that all the data points within a cluster are homogenous and heterogeneous from the data in other clusters, k-means creates clusters wherein the k-means process selects k centroids, or points, for each cluster, with the closest centroids, each data point creates a cluster from a plurality of member of the current cluster, which generates new centroids, a closest distance for every data point is calculated using the new centroids, up until the centroids stay the same, and
a transmitter being operably coupled to the generator and being operable to transmit the life science project communication.

8. The system of claim 7, wherein the first receiver is further operable to receive the curated data and the enriched data from a National Institutes of Health (NIH) database, a National Science Foundation (NSF) database, a Canadian Institutes of Health Research (CIHR) database, a foundation database, a venture capital organization database, a scientific conference database and a publications database.

9. The system of claim 7, wherein the curated data and the enriched data is missing contact details, wherein the missing contact details include address, phone, and email address.
